(19) United States
(12) Patent Application Publication
(10) Pub. No.: US 2019/0220036 A1
(43) Pub. Date: Jul. 18, 2019

(54) Systems and Methods for Implementing Vehicle Assignments using Vehicle State Information

(71) Applicant: Uber Technologies, Inc., San Francisco, CA (US)

(72) Inventors: Emily Anna Weslosky, San Francisco, CA (US); Gary Wu Yang, San Francisco, CA (US); Nuri Kim, San Francisco, CA (US); Lili Kan, Cupertino, CA (US); Varun Rau, San Francisco, CA (US); Xiaoman Dong, Burlingame, CA (US); Julie Marie Derence, Pittsburgh, PA (US); Christopher John Peplin, Pittsburgh, PA (US); Daniel Joseph Tascione, Monroeville, PA (US); Steve Ayers, Mars, PA (US); Mark Reeder, Menlo Park, CA (US); Robert Eperjesi, San Francisco, CA (US); Richard Tom, San Francisco, CA (US); Steven Hanby Williams, Sunnyvale, CA (US); Venkata Sathya Praveen Gorthy, Pleasanton, CA (US); Sunil Kumar Garg, San Francisco, CA (US); Chris Lyons, San Francisco, CA (US); Yi Shi, San Francisco, CA (US)

(21) Appl. No.: 15/898,960

(22) Filed: Feb. 19, 2018

Related U.S. Application Data
(60) Provisional application No. 62/618,383, filed on Jan. 17, 2018.

(51) Int. Cl. G05D 1/02; G07C 5/00; G07C 5/08; G08G 1/00; G06Q 50/30

(52) U.S. Cl. CPC G05D 1/0291; G07C 5/008; G06Q 50/30; G08G 1/202; G07C 5/08

(57) ABSTRACT

Systems and methods for managing a fleet of vehicles are provided. In one example embodiment, a computer-implemented method includes obtaining data representing vehicle state information associated with one or more vehicles among a fleet of vehicles at one or more times. The method includes predicting a future vehicle state associated with the one or more vehicles at one or more future times. The method includes scheduling a vehicle assignment in a predetermined set of vehicle assignments for a selected vehicle among the one or more vehicles before a first future time among the one or more future times. The method includes transmitting a command signal to a computing system associated with the selected vehicle based at least in part on the scheduled vehicle assignment.

### PRIORITY CLAIM

The present application claims the benefit of priority of U.S. Provisional Patent Application No. 62/618,383 filed Jan. 17, 2018, entitled “Systems and Methods for Implementing Vehicle Assignments Using Vehicle State Information.” The above-referenced patent application is incorporated herein by reference.

### FIELD

The present disclosure relates generally to managing a fleet of vehicles, and in particular, scheduling vehicle assignments using vehicle state information and controlling the vehicles to implement the vehicle assignments.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion plan through such surrounding environment.

### SUMMARY

Aspects and advantages of the present disclosure will be set forth in part in the following description, or may be learned from the description, or may be learned through practice of the embodiments.

One example aspect of the present disclosure is directed to a computer-implemented method for managing a fleet of vehicles. The method includes obtaining data representing vehicle state information associated with one or more vehicles among a fleet of vehicles at one or more times. The method includes predicting a future vehicle state associated with the one or more vehicles at one or more future times based at least in part on the vehicle state information. The method includes scheduling a vehicle assignment in a predetermined set of vehicle assignments for a selected vehicle among the one or more vehicles before a first future time among the one or more future times based at least in part on a future vehicle state associated with the selected vehicle at the first future time. The method includes transmitting a command signal to a computing system associated with the selected vehicle based at least in part on the scheduled vehicle assignment.

Another example aspect of the present disclosure is directed to a computer-implemented method for implementing a vehicle assignment. The method includes obtaining data representing vehicle state information associated with a vehicle at one or more collection times. The method includes transmitting the vehicle state information to one or more remote computing systems at one or more transmission times. The method includes receiving a command signal from the one or more remote computing systems, the command signal indicative of a scheduled vehicle assignment for the vehicle based at least in part on the vehicle state information. The method includes controlling, in response to the command signal, the vehicle to implement the scheduled vehicle assignment based at least in part on the command signal.

Yet another example aspect of the present disclosure is directed to a computing system for managing a fleet of vehicles. The computing system includes a fleet of vehicles, a fleet manager that manages the fleet of vehicles, one or more processors and one or more tangible, non-transitory, computer readable media that collectively store instructions that when executed by the one or more processors cause the computing system to perform operations. The operations include collecting, by one or more vehicle in the fleet, data representing vehicle state information associated with the one or more vehicles at one or more collection times. The operations include transmitting, by the one or more vehicles, data representing the vehicle state information associated with the one or more vehicles, to the fleet manager at one or more transmission times. The operations include obtaining, by the fleet manager, data representing the vehicle state information. The operations include predicting, by the fleet manager, a future vehicle state associated with the one or more vehicles at one or more future times based at least in part on the vehicle state information. The operations include scheduling, by the fleet manager, a vehicle assignment in a predetermined set of vehicle assignments for a selected vehicle among the one or more vehicles before a first future time among the one or more future times based at least in part on a future vehicle state associated with the selected vehicle at the first future time. The operations include transmitting, by the fleet manager, a command signal to the selected vehicle based at least in part on the scheduled vehicle assignment, the command signal indicative of the scheduled vehicle assignment for the selected vehicle. The operations include receiving, by the selected vehicle, a command signal from the one or more remote computing systems, the command signal indicative of a scheduled vehicle assignment for the vehicle based at least in part on the vehicle state information. The operations include implementing, by the selected vehicle, the scheduled vehicle assignment in response to the command signal.

Other example aspects of the present disclosure are directed to systems, methods, vehicles, apparatuses, tangible, non-transitory computer-readable media, and memory devices for controlling an autonomous vehicle.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth below, which make reference to the appended figures, in which:

FIG. 1 depicts a block diagram of an example system overview according to example embodiments of the present disclosure;

FIG. 2 depicts a block diagram of an example vehicle computing system according to example embodiments of the present disclosure;

FIG. 3 depicts a block diagram of an example vehicle operations system interface according to example embodiments of the present disclosure;

FIG. 4 depicts example vehicle state information according to example embodiments of the present disclosure;

FIG. 5 depicts example vehicle state information according to example embodiments of the present disclosure;

FIGS. 6A-6C depict example vehicle state information according to example embodiments of the present disclosure;

FIG. 7 depicts example vehicle assignment information according to example embodiments of the present disclosure;

FIG. 8 depicts a flow diagram of managing a fleet of vehicles according to example embodiments of the present disclosure;

FIG. 9 depicts a flow diagram of implementing a vehicle assignment according to example embodiments of the present disclosure; and

FIG. 10 depicts example system components according to example embodiments of the present disclosure.

Reference numerals that are repeated across plural figures are intended to identify the same components or features in various implementations.

### DETAILED DESCRIPTION

Example aspects of the present disclosure are directed to communication between vehicles in a fleet and an entity infrastructure, for example, a service provider's operations or control center. In particular, the systems and methods of the present disclosure can facilitate secure, bidirectional communications between one or more vehicles in a service provider's fleet and the service provider's operations or control center. The systems and methods of the present disclosure can provide for accessing vehicle state information associated with the vehicles in the fleet, and scheduling vehicle assignments for the vehicles based on the vehicle state information. In this fashion, systems and methods can be provided that advantageously implement dynamic control of vehicle state monitoring and assignment scheduling across an entire fleet of vehicles.

In particular, according to aspects of the present disclosure, a vehicle application programming interface (Vehicle API) platform can provide for a translation/transport layer as an interface between vehicle computing systems onboard vehicles within an entity's fleet and one or more remote clients and/or applications operating within the entity's operations/control center. For example, the Vehicle API platform can receive data from a vehicle over a communications pipeline established with the Vehicle API. The Vehicle API platform can provide for communicating vehicle data to the operations/control center in a secure manner that allows for expanded processing of vehicle data off the vehicle, analyzing such data in real time, and/or the like. According to example aspects of the present disclosure, a Vehicle API platform can be vehicle agnostic, allowing for any autonomous vehicle and/or computer-capable vehicle to interact with an entity's operations/control center by providing a consistent communication pipeline that any vehicle computing system would be able to use to report vehicle data (e.g., vehicle state information, etc.) and/or receive messages (e.g., command/control messages, configuration messages, etc.) from an entity's operations system.

More particularly, an entity (e.g., service provider, owner, manager) can use one or more vehicles (e.g., ground-based vehicles) to perform one or more tasks in a predetermined set of tasks. The predetermined set of tasks can include, for example, providing a vehicle service such as a transportation service (e.g., rideshare service), a courier service, a delivery service, etc., collecting vehicle state information, collecting map data associated with an environment, collecting sensor data associated with one or more vehicle components onboard the one or more vehicle. The one or more vehicles can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can receive sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment. Moreover, the autonomous vehicle can be configured to communicate with one or more computing devices that are remote from the vehicle. For example, the autonomous vehicle can communicate with an operations computing system that can be associated with the entity. The operations computing system can help the entity monitor, communicate with, manage, etc. the fleet of vehicles.

In some implementations, the Vehicle API platform can provide for a vehicle to send multiple types of data to the service provider system over the established connections between the vehicle and the service provider system. For example, in some implementations, the Vehicle API platform can provide for a vehicle to send vehicle state information to the service provider system. In some implementations, the Vehicle API platform can provide for a vehicle to send low resolution perception data, such as labels and/or geometries, to the service provider system, allowing for processing the data offboard the vehicle and developing better understanding of the world. In some implementations, the Vehicle API platform can provide for a vehicle to send data such as current vehicle pose (e.g., global and relative to map), vehicle trajectory, onboard diagnostics, and/or the like, to the service provider system.

In some implementations, the Vehicle API platform can provide for aggregating data from multiple vehicles allowing for an understanding of what the vehicles are doing in that particular moment in time. For example, in some implementations, the Vehicle API platform can provide for aggregating data from a vehicle to allow for determining what a particular vehicle is doing, to allow for tracking vehicle in real time, and/or the like. In some implementations, the Vehicle API platform can provide for streaming real time data from a vehicle, for example, providing a live stream of telemetry data from a vehicle to an operations system to allow for providing assistance to the vehicle. In some implementations, by providing for aggregating vehicle data, the Vehicle API platform can facilitate understanding of what all the vehicles are in a fleet, who they belong to, what they are doing, providing a history for some time window into the behavior of a vehicle, providing moving snapshots of vehicle data over time, and/or the like.

In some implementations, the Vehicle API platform can provide for a vehicle to send data including vehicle state information associated with the vehicle. The vehicle state information can include, for example, one or more vehicle attributes associated with the vehicle at any given time. The Vehicle API platform can provide for the vehicle to send data including one or more vehicle attributes associated with the vehicle at one or more times. The vehicle attributes can include, for example, vehicle activity information, vehicle schedule information, trip availability information, and/or vehicle readiness information.

In some implementations, the vehicle attributes associated with a vehicle can include vehicle activity information.

The vehicle attributes can include “autonomous mode”, for example, when the vehicle is operating autonomously and navigating to a destination, when the vehicle is operating autonomously and is stationary, etc.

The vehicle attributes can include “manual mode”, for example, when a vehicle operator is manually operating the vehicle to navigate to a destination, when a vehicle operator is manually operating the vehicle and the vehicle is stationary, etc.

The vehicle attributes can include “deploying”, for example, when the vehicle is deploying, etc.

The vehicle attributes can include “parked”, for example, when a transmission of the vehicle set to “park”, etc.

The vehicle attributes can include “keyed-off”, for example, when the last known vehicle attribute associated with the vehicle indicates that the vehicle is parked and a predetermined amount of time has since elapsed, etc.

The vehicle attributes can include “no-signal”, for example, when the vehicle is not associated with one of autonomous mode, manual mode, deploying, parked, or keyed-off.

In some implementations, the vehicle attributes associated with a vehicle can include vehicle schedule information.

The vehicle attributes can include “scheduled”, for example, when the vehicle is scheduled for operation, etc.

The vehicle attributes can include “not scheduled”, for example, when the vehicle is not scheduled for operation, etc.

The vehicle attributes can include “assigned”, for example, when a vehicle operator is assigned to operate the vehicle, etc.

The vehicle attributes can include “not assigned”, for example, when a vehicle operator is not assigned to operate the vehicle, etc. The vehicle attributes can further include, for example, whether a vehicle operator is available to operate the vehicle, etc.

The vehicle attributes can include “logged-in”, for example, when a vehicle operator is logged-in to the vehicle, etc.

The vehicle attributes can include “not logged-in”, for example, when a vehicle operator is not logged-in to the vehicle, etc. The vehicle attributes can further include, for example, whether the vehicle operator is not logged-in because the vehicle operator is taking a break, the vehicle operator has scheduled down-time, etc.

The vehicle attributes can include “operational”, for example, when the vehicle is scheduled for operation, a vehicle operator is assigned to operate the vehicle, and the assigned vehicle operator is logged-in to the vehicle.

The vehicle attributes can include “non-operational”, for example, when the vehicle is not scheduled for operation, when a vehicle operator is not assigned to operate the vehicle, when a vehicle operator is not logged-in to the vehicle, when a vehicle operator that is not assigned to operate the vehicle is logged-in to the vehicle, etc.

In some implementations, the vehicle attributes associated with a vehicle can include trip availability information.

The vehicle attributes can include “available”, for example, when a vehicle operator is scheduled to operate the vehicle, the vehicle operator is logged-in to the vehicle, and the vehicle is available to perform one or more tasks in the predetermined set of tasks; etc.

The vehicle attributes can include “not available”, for example, when a vehicle operator is scheduled to operate the vehicle, the vehicle operator is logged-in to the vehicle, and the vehicle is not available to perform one or more tasks in the predetermined set of tasks; etc. The vehicle attributes can further include, for example, whether the vehicle is not available because the vehicle operator is cleaning the vehicle, the vehicle operator is refueling the vehicle, the vehicle operator is returning the vehicle to a vehicle base, etc.

In some implementations, the vehicle attributes associated with a vehicle can include vehicle readiness information.

The vehicle attributes can include “ready”, for example, when the vehicle is ready to perform one or more tasks in the predetermined set of tasks, etc.

The vehicle attributes can include “troubleshooting”, for example, when an entity is troubleshooting the vehicle. The vehicle attributes can further include, for example, an identification of the entity troubleshooting the vehicle, whether the troubleshooting is tier 1 (e.g., remote troubleshooting), whether the troubleshooting is tier 2 (e.g., hand-on trouble shooting by a vehicle reliability team), etc.

The vehicle attributes can include “grounded”, for example, when the vehicle cannot perform one or more tasks in the predetermined set of tasks. The vehicle attributes can further include, for example, whether the vehicle cannot perform one or more tasks because of maintenance (e.g., oil change, engine service, brake replacement, etc.), fleet rollout (e.g., vehicle software updates, vehicle hardware upgrades, etc.), etc.

In some implementations, the Vehicle API platform can provide for a service provider system to receive data including vehicle state information associated with one or more vehicle in the fleet at a given time. The Vehicle API platform can provide for the service provider system to receive the data from one or more sources (e.g., from one or more vehicles in the fleet, one or more remote computing systems, etc.). The Vehicle API platform can provide for the service provider system to aggregate data including vehicle state information associated with a vehicle from the one or more sources. The service provider system can, for example, analyze the data to determine a vehicle state associated with the one or more vehicles at the given time. A vehicle state for a vehicle at the given time can indicate, for example, one or more vehicle attributes associated with the vehicle at the given time. The service provider system can, for example, determine a vehicle utility score associated with the one or more vehicles at the given time. Each of the one or more vehicle attributes associated with the vehicle can be associated with a predetermined utility value. The vehicle utility score for a vehicle at the given time can be determined, for example, based on a vehicle utility score function that outputs the vehicle utility score based on the predetermined utility values associated with the one or more vehicle attributes associated with the vehicle at the given time. Additionally, the service provider system can, for example, determine a fleet utility score associated with the fleet at the given time. The fleet utility score can be determined, for example, based on a fleet utility function that outputs the fleet utility score based on the vehicle utility scores associated with the one or more vehicles in the fleet.

In some implementations, the Vehicle API platform can provide for a service provider system to aggregate data (e.g., vehicle state information) associated with one or more vehicles in the fleet at one or more times. The service provider system can, for example, analyze the data to determine a vehicle state associated with the one or more vehicles at the one or more times, and determine a vehicle utilization score associated with the one or more vehicles over a predetermined duration (e.g., a previous hour, day, week, month, year, etc.). A vehicle utilization score for a vehicle can indicate, for example, a fraction of the predetermined duration that the vehicle is associated with vehicle attributes such as autonomous mode, manual mode, offloading, or deploying. In some implementations, the vehicle utilization score for the vehicle can be based on a vehicle utility score associated with the vehicle at one or more times within the predetermined duration. In some implementations, the vehicle utilization score can be determined based on a vehicle utilization function that outputs the vehicle utilization score based on the vehicle utility scores associated with the one or more vehicles in the fleet. Additionally, the service provider system can, for example, determine a fleet utilization score associated with the fleet over the predetermined duration. The fleet utilization score can be determined, for example, based on a fleet utilization function that outputs the fleet utilization score based on vehicle utilization scores associated with the one or more vehicles in the fleet.

In some implementations, the Vehicle API platform can provide for a service provider system to determine one or more utilization patterns associated with one or more vehicles in the fleet. The one or more utilization patterns associated with a vehicle can indicate, for example, one or more times that the vehicle is associated with a particular vehicle attribute or set of vehicle attributes. The one or more utilization patterns can include, for example, a pattern corresponding to when a vehicle is performing one or more tasks in the predetermined set of tasks, a pattern corresponding to when a vehicle is not performing one or more tasks in the predetermined set of tasks, a pattern corresponding to when a vehicle is operating in autonomous mode, a pattern corresponding to when a vehicle is operating in manual mode, a pattern corresponding to when a vehicle is offloading, a pattern corresponding to when a vehicle is deploying, a pattern corresponding to when a vehicle is parked, a pattern corresponding to when a vehicle is keyed off, a pattern corresponding to when a vehicle is associated with no signal, a pattern corresponding to when a vehicle is scheduled for operation, a pattern corresponding to when a vehicle is not scheduled for operation, a pattern corresponding to when a vehicle operator is signed in to the vehicle, a pattern corresponding to when a vehicle operator is not signed in to the vehicle, a pattern corresponding to when no vehicle operator is available to be scheduled for the vehicle, a pattern corresponding to when a vehicle is scheduled for down time, a pattern corresponding to when a vehicle is not available for a trip because the vehicle is being cleaned, a pattern corresponding to when a vehicle is not available for a trip because the vehicle is being returned to a vehicle base, a pattern corresponding to when a vehicle is not available for a trip because the vehicle is being refueled, a pattern corresponding to when a vehicle is ready, a pattern corresponding to when an entity is troubleshooting a vehicle, a pattern corresponding to when a vehicle is grounded because of routine maintenance, a pattern corresponding to when a vehicle is grounded because of a fleet rollout, etc.

In some implementations, the Vehicle API platform can provide for a service provider system to extrapolate one or more utilization patterns associated with a vehicle to one or more future times to predict one or more vehicle attributes associated with the vehicle at the one or more future times. In some implementations, the service provider system can, for example, extrapolate the one or more utilization patterns to predict a future vehicle state associated with the vehicle at a future time, and predict a future vehicle utility score associated with the vehicle at the future time. Additionally, the service provider system can, for example, predict a future fleet utility score associated with the fleet at the future time. In some implementations, the service provider system can, for example, extrapolate the one or more utilization patterns to predict a future vehicle state associated with the vehicle at the one or more future times, and predict a future vehicle utilization score associated with the vehicle over a predetermined duration (e.g., a future hour, day, week, month, year, etc.). Additionally, the service provider system can, for example, predict a future fleet utilization score associated with fleet over the predetermined duration.

In some implementations, the Vehicle API platform can provide for the service provider system to send multiple types of data to a vehicle over the established connections to the vehicle. For example, in some implementations, the Vehicle API platform can provide for sending vehicle assignment data to a vehicle, such as instructions for a vehicle to offload the data from its computing system, instructions for a vehicle to report for maintenance, instructions for a vehicle to procure fuel, and/or the like. In some implementations, the Vehicle API platform can provide for sending command signals to a vehicle, such as, for example, sending specific control messages to a vehicle, sending advisories to vehicles, etc. The specific control messages can, for example, instruct the vehicle to go to certain coordinates. The advisories can, for example, notify a vehicle operator associated with the vehicle about scheduled vehicle assignments, flagged geo regions (e.g., areas to avoid, areas to spend more time in to acquire passengers, areas under construction that should be routed around, etc.), etc.

In some implementations, the Vehicle API platform can provide for a service provider system to schedule a vehicle assignment in a predetermined set of vehicle assignments. A vehicle assignment can include instructions for a vehicle to perform one or more actions. The service provider system can schedule a vehicle assignment for a vehicle at one or more future times for the vehicle to implement the vehicle assignment at the one or more future times by performing the one or more actions. In some implementations, the predetermined set of vehicle assignments can include, for example, maintenance assignments, fleet rollout assignments, trade dressing assignments, event assignments, etc. In some implementations, a vehicle assignment can be associated with one or more assignment attributes, such as, for example, scheduled times, locations, expected durations, required preconditions, contact information, notes, etc.

In some implementations, a maintenance assignment can include, for example, instructions for a vehicle to refuel, obtain an oil change, repair broken components, replace worn components (e.g., tires, brake pads, etc.), etc. The maintenance assignment can be associated with assignment attributes including, for example, a maintenance type (e.g., oil change, repair, etc.), maintenance time, maintenance location (e.g., commercial gas station, maintenance garage, etc.), expected maintenance duration (e.g., expected duration for an oil change, expected duration for tire replacement, etc.), maintenance preconditions (e.g., threshold fuel level remaining before refueling, threshold distance traveled before an oil change, threshold redundancy loss before repairing broken components, threshold performance degradation before repairing worn components, etc.), etc.

In some implementations, a fleet rollout assignment can include, for example, instructions for a vehicle to update one or more components (e.g., software components), replace one or more components (e.g., hardware components), add one or more components (e.g., software and/or hardware components), etc., as part of a rollout to one or more vehicles in the fleet. The fleet rollout assignment can be associated with assignment attributes including, for example, a start date/time to begin a rollout to vehicles in a fleet, a completion date/deadline to finish the rollout, locations (e.g., one or more maintenance garages that a vehicle can access to implement a fleet rollout assignment), expected durations (e.g., expected duration to update, replace, and/or add one or more components associated with the fleet rollout), required preconditions (e.g., availability of a maintenance garage to receive a vehicle at a future time, inventory at a maintenance garage of one or more vehicle components associated with the fleet rollout, bandwidth and resource availability restrictions on data associated with the fleet rollout, etc.), etc.

In some implementations, a trade dressing assignment can include, for example, instructions for a vehicle to perform an action associated with a trade dress. The trade dress assignment can be associated with one or more corresponding assignment attributes.

In some implementations, an event assignment can include, for example, instructions for a vehicle to perform an event at a predetermined future time. The service provider system can obtain event data including one or more events to be performed at one or more future times, and schedule one or more event assignments for a vehicle to perform the one or more events at the one or more future times. The service provider system can obtain the event data, for example, from a calendar of events that is maintained and/or updated by one or more remote clients and/or applications operating within the service provider system, and/or from one or more remote computing devices. The event assignment can be associated with assignment attributes including, for example, a scheduled time of an event associated with the event assignment, location associated with the event, expected duration of the event, notes that describe the event, etc.

In some implementations, the Vehicle API platform can allow for a service provider system to select a vehicle to implement a vehicle assignment at a future time based on a future vehicle state associated with the selected vehicle.

As an example, the service provider system can determine that a future vehicle state predicted for a vehicle at a first future time will indicate that the vehicle will have traveled a distance that exceeds an oil change threshold distance. The service provider system can select the vehicle to implement a maintenance assignment (e.g., for the selected vehicle to obtain an oil change) at the first future time, and schedule the maintenance assignment for the selected vehicle at the first future time. Maintenance assignments for other maintenance events than oil changes can be determined in a similar fashion.

As another example, the service provider system can predict a future vehicle utility score associated with a selected vehicle at two or more future times. The service provider system can compare the future vehicle utility scores to determine a future time when the vehicle utility score is lowest. The service provider system can schedule a vehicle assignment for the selected vehicle at the future time when the vehicle utility score is lowest.

As another example, the service provider system can select a vehicle to implement a vehicle assignment associated with a an expected duration. The service provider system can predict a future vehicle utilization score associated with the selected vehicle over two or more future durations. Each of the future durations can be associated with a future start time for the duration, and extend at least as long as the expected duration. The service provider system can compare the future vehicle utilization scores to determine a future duration when the vehicle utilization score is lowest. The service provider system can schedule the vehicle assignment for the selected vehicle at the future start time when the vehicle utilization score is lowest.

In some implementations, the Vehicle API platform can allow for a service provider system to select a vehicle to implement a vehicle assignment at a future time based on a future vehicle state associated with a plurality of vehicles in the fleet at the future time.

As an example, the service provider system can select a vehicle to implement an event assignment associated with a first future time. The service provider system can predict a future vehicle state associated with a plurality of vehicles in the fleet at the first future time, and predict a future vehicle utility score associated with each of the plurality of vehicles at the first future time. The service provider system can determine a vehicle among the plurality of vehicles that is associated with a lowest future vehicle utility score, and select the vehicle to implement the event assignment at the first future time. Alternatively, the service provider system can determine one or more vehicles among the plurality of vehicles that are associated with a vehicle utility score below a predetermined threshold score, and select a vehicle to implement the event assignment from among the one or more determined vehicles. Alternatively, the service provider system can predict a fleet utility score at the first future time, and select a vehicle to implement the event assignment such that the fleet utility score is maximized or otherwise increased. The service provider system can schedule the event assignment for the selected vehicle at the first future time.

As another example, the service provider system can select a vehicle to implement an assignment associated with a first future time and an expected duration. The service provider system can predict a future vehicle state associated with a plurality of vehicles in the fleet at one or more future times proximate to the first future time, and predict a future vehicle utilization score associated with each of the plurality of vehicles over the expected duration starting at the first future time. The service provider system can determine a vehicle among the plurality of vehicles that is associated with a lowest future vehicle utilization score, and select the vehicle to implement the vehicle assignment at the first future time. Alternatively, the service provider system can determine one or more vehicles among the plurality of vehicles that are associated with a vehicle utilization score below a predetermined threshold score, and select a vehicle to implement the vehicle assignment from among the one or more determined vehicles.

Alternatively, the service provider system can predict a fleet utilization score over the expected duration starting at the first future time, and select a vehicle to implement the vehicle assignment such that the fleet utilization score is maximized or otherwise increased. The service provider system can schedule the vehicle assignment for the selected vehicle at the first future time.

In some implementations, the Vehicle API platform can allow for a service provider system to determine one or more preconditions associated with a vehicle assignment. The service provider system can schedule the vehicle assignment based on the one or more preconditions.

As an example, a maintenance assignment to refuel can be associated with a precondition that a vehicle's fuel tank is less than a quarter full. The service provider system can determine that a future vehicle state predicted for the vehicle at a first future time will indicate that the vehicle's fuel tank will be less than a quarter full. The service provider system can schedule the maintenance assignment for the vehicle in proximity to the first future time.

As another example, a fleet rollout assignment to install a new hardware component can be associated with a first precondition that a maintenance location is able to accommodate the vehicle, and a second precondition that the maintenance location has an inventory of the new hardware component. The service provider system can schedule the fleet rollout assignment for the vehicle at a first future time when the first and second preconditions are met.

In some implementations, the Vehicle API platform can provide for a service provider system to edit a scheduled vehicle assignment. The service provider system can edit a scheduled vehicle assignment, for example, in response to determining updated vehicle state information and/or updated vehicle assignment information.

As an example, the service provider system can predict that a vehicle's fuel tank will be less than a quarter full at a first future time, and schedule a maintenance assignment to refuel the vehicle at the first future time. The service provider system can receive data including updated vehicle state information from the vehicle at one or more times before the first future time, and predict an updated future vehicle state associated with the vehicle. The updated future vehicle state can indicate, for example, that the vehicle's fuel tank will be less than a quarter full at a second future time before/after the first future time. The service provider can reschedule the maintenance assignment for the vehicle at the second future time, based on the updated vehicle state information.

As another example, the service provider system can schedule a fleet rollout assignment to install a new hardware component for a vehicle at a first future time based on a vehicle utilization score associated with the vehicle for an expected duration of the fleet rollout assignment starting at the first future time. The service provider system can later determine an updated expected duration associated with the fleet rollout assignment that is shorter. The service provider system can update the scheduled vehicle assignment to reflect the shorter expected duration. Additionally, if the service provider system predicts that the vehicle will be associated with a lower vehicle utilization score over the updated expected duration starting at a second future time, then the service provider system can reschedule the fleet rollout assignment at the second future time.

In some implementations, Vehicle API platform can provide for a service provider system to send a control message to a vehicle instructing the vehicle to implement a scheduled vehicle assignment. For example, the service provider system can provide a control message instructing the vehicle to autonomously travel to a location associated with the vehicle assignment at a scheduled time associated with the vehicle service.

In some implementations, the Vehicle API platform can provide for a service provider system to send an advisory to a vehicle to notify a vehicle operator associated with the vehicle of a vehicle assignment scheduled for the vehicle. The advisory can include one or more attributes associated with the vehicle assignment, such as for example, a scheduled time, location, expected duration, etc. In some implementations, the service provider system can provide one or more advisories at one or more times ahead of a scheduled time associated with the vehicle assignment.

In some implementations, the Vehicle API platform can provide for a service provider system to send an advisory to a vehicle based on vehicle state information associated with the vehicle. The service provider system can provide the advisory based on a predetermined set of rules corresponding to the vehicle state information. For example, the service provider system can provide an advisory to a vehicle to notify a vehicle operator associated with the vehicle that a vehicle attribute associated with the vehicle has changed, indicating that the vehicle's activity has changed from being grounded to being ready.

The systems and methods described herein provide a number of technical effects and benefits. Systems and methods for accessing vehicle state information associated with the vehicles can have a technical effect of improving efficiency in fleet resource management. By enabling access, collection, and analysis of the vehicle state information, a future vehicle utility/utilization and a future fleet utility/utilization can be predicted. In this way, vehicle assignments can be scheduled for vehicles so that the utility/utilization can be improved. Additionally, the systems and methods can enable dynamic control of vehicle state monitoring and assignment scheduling across the fleet of vehicles.

The systems and methods of the present disclosure also provide an improvement to vehicle computing technology, such as autonomous vehicle computing technology. For instance, the systems and methods herein enable the vehicle technology to collect and provide detailed vehicle state information. For example, the systems and methods can allow one or more computing system(s) on-board an autonomous vehicle (and/or off-board a vehicle) to collect vehicle state information, determine utilization patterns, and predict future utility/utilization.

### Example Embodiments

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

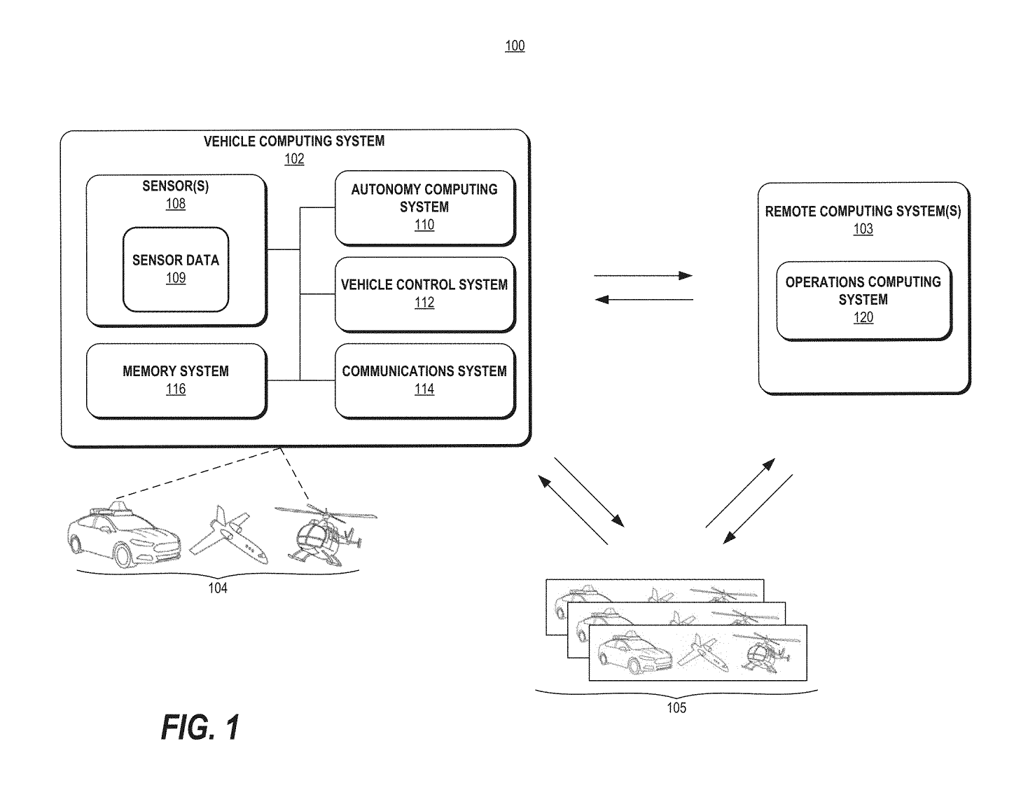

With reference now to the FIGS., example embodiments of the present disclosure will be discussed in further detail. FIG. 1 depicts an example system 100 according to example embodiments of the present disclosure. The system 100 can include a vehicle computing system 102 associated with a vehicle 104. The system 100 can also include one or more additional vehicle(s) 105, each including a respective vehicle computing system (not shown).

In some implementations, the system 100 can include one or more remote computing system(s) 103 that are remote from the vehicle 104 and the additional vehicle(s) 105. The remote computing system(s) 103 can include an operations computing system 120. The remote computing system(s) 103 can be separate from one another or share computing device(s). The operations computing system 120 can remotely manage the vehicle 104.

In some implementations, the vehicle 104 can be part of a fleet of vehicles managed by the operations computing system 120. Additionally, the one or more additional vehicle(s) 105 can be part of the fleet of vehicles managed by the operations computing system 120.

The vehicle computing system 102 can include one or more computing device(s) located on-board the vehicle 104 (e.g., located on and/or within the vehicle 104). The computing device(s) can include various components for performing various operations and functions. For instance, the computing device(s) can include one or more processor(s) and one or more tangible, non-transitory, computer readable media. The one or more tangible, non-transitory, computer readable media can store instructions that when executed by the one or more processor(s) cause the vehicle 104 (e.g., its computing system, one or more processors, etc.) to perform operations and functions, such as those described herein.

In some implementations, the vehicle computing system 102 can include a Vehicle API client that can enable bidirectional communication with a service provider's system (e.g., an operations computing system) through a Vehicle API Platform operating on the service provider's system. For example, the Vehicle API Platform and the Vehicle API client can provide for establishing communication tunnels between the vehicle computing system and the service provider system. In some implementations, the Vehicle API client can provide for communicating data using intelligent quality of service (QoS), multiplexing data over different communication streams, prioritizing and/or de-prioritizing data traffic dynamically, for example, based on link conditions and/or the like.

In some implementations, the operations computing system 120 can include a Vehicle API platform that can provide for a translation/transport layer as an interface between vehicle computing systems onboard vehicles within an entity's fleet and one or more remote clients and/or applications operating within the entity's operations/control center. For example, the Vehicle API platform can receive data from a vehicle over a communications pipeline established between the Vehicle API and the vehicle (e.g., the vehicle computing system) and provide for different means of classifying the data, writing the data consistently on different messaging protocols, and providing a platform that can aggregate data for other clients/applications in consistent ways. The Vehicle API platform can provide for communicating vehicle data to the operations/control center in a secure manner that allows for expanded processing of vehicle data off the vehicle, analyzing such data in real time, and/or the like.

As shown in FIG. 1, the vehicle 104 can include one or more sensors 108, an autonomy computing system 110, a vehicle control system 112, a communications system 114, and a memory system 116. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The on-board systems can send and/or receive data, messages, signals, etc. amongst one another via the communication channel.

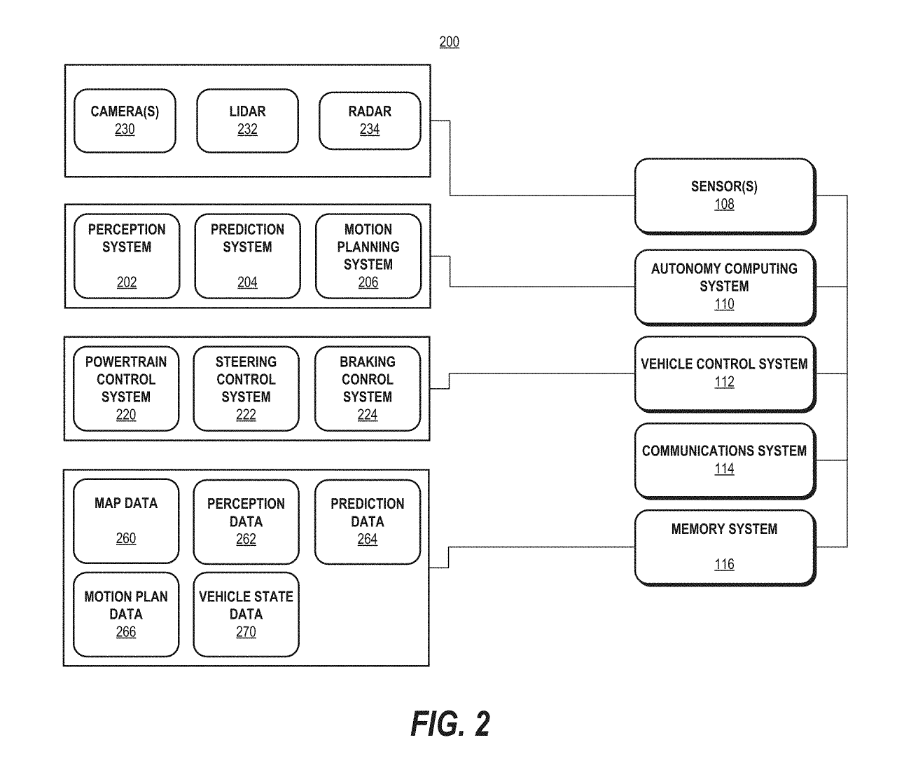

The sensor(s) 108 can be configured to acquire sensor data 109 associated with one or more objects that are proximate to the vehicle 104 (e.g., within a field of view of one or more of the sensor(s) 108). As shown in FIG. 2, the sensor(s) 108 can include one or more cameras 230 (e.g., visible spectrum cameras, infrared cameras, etc.), a Light Detection and Ranging (LIDAR) system 232, a Radio Detection and Ranging (RADAR) system 234, motion sensors, and/or other types of imaging capture devices and/or sensors. The sensor data 109 can include image data, radar data, LIDAR data, and/or other data acquired by the sensor(s) 108. The object(s) can include, for example, pedestrians, vehicles, bicycles, and/or other objects. The object(s) can be located in front of, to the rear of, and/or to the side of the vehicle 104. The sensor data 109 can be indicative of locations associated with the object(s) within the surrounding environment of the vehicle 104 at one or more times. The sensor(s) 108 can provide the sensor data 109 to the autonomy computing system 110.

As shown in FIG. 2, the autonomy computing system 110 can include a perception system 202, a prediction system 204, a motion planning system 206, and/or other systems that cooperate to perceive the surrounding environment of the vehicle 104 and determine a motion plan for controlling the motion of the vehicle 104 accordingly. For example, the autonomy computing system 110 can receive the sensor data 109 from the sensor(s) 108, attempt to comprehend the surrounding environment by performing various processing techniques on the sensor data 109 (and/or other data), and generate an appropriate motion plan through such surrounding environment. The autonomy computing system 110 can control one or more components of the vehicle control system 112 to operate the vehicle 104 according to the motion plan.

The autonomy computing system 110 can identify one or more objects that are proximate to the vehicle 104 based at least in part on the sensor data 109. For instance, the perception system 202 can perform various processing techniques on the sensor data 109 to determine perception data 262 that is descriptive of a current state of one or more object(s) that are proximate to the vehicle 104. The prediction system 204 can create prediction data 264 associated with each of the respective one or more object(s) proximate to the vehicle 104. The prediction data 264 can be indicative of one or more predicted future locations of each respective object. The motion planning system 206 can determine a motion plan for the vehicle 104 based at least in part on the prediction data 264 (and/or other data), and save the motion plan as motion plan data 266. The motion plan data 266 can include vehicle actions with respect to the object(s) proximate to the vehicle 104 as well as the predicted movements. The motion plan data 266 can include a planned trajectory, speed, acceleration, etc. of the vehicle 104.

The motion planning system 206 can provide at least a portion of the motion plan data 266 that indicates one or more vehicle actions, a planned trajectory, and/or other operating parameters to the vehicle control system 112 to implement the motion plan for the vehicle 104. For instance, the vehicle 104 can include a mobility controller configured to translate the motion plan data 266 into instructions. By way of example, the mobility controller can translate the motion plan data 266 into instructions to adjust the steering of the vehicle 104 “X” degrees, apply a certain magnitude of braking force, etc. The mobility controller can send one or more control signals to one or more responsible system(s) included in the vehicle control system (e.g., powertrain control system 220, steering control system 222, braking control system 224) to execute the instructions and implement the motion plan.

The communications system 114 can allow the vehicle computing system 102 (and its computing system(s), additional vehicle(s) 105) to communicate with other computing systems (e.g., remote computing system(s) 103). For example, the vehicle computing system 102 can use the communications system 114 to communicate with the operations computing system 120 over one or more networks (e.g., via one or more wireless signal connections). In some implementations, the communications system 114 can allow communication among one or more of the system(s) on-board the vehicle 104. The communications system 114 can include any suitable sub-systems for interfacing with one or more network(s), including, for example, transmitters, receivers, ports, controllers, antennas, and/or other suitable sub-systems that can help facilitate communication.

The memory system 116 of the vehicle 104 can include one or more memory devices located at the same or different locations (e.g., on-board the vehicle 104, distributed throughout the vehicle 104, off-board the vehicle 104, etc.). The vehicle computing system 102 can use the memory system 116 to store and retrieve data/information. For instance, the memory system 116 can store map data 260, perception data 262, prediction data 264, motion plan data 266, and vehicle state data 270.

The map data 260 can include information regarding: an identity and location of different roadways, road segments, buildings, or other items or objects (e.g., lampposts, crosswalks, curbing, etc.); a location and direction of traffic lanes (e.g., the location and direction of a parking lane, a turning lane, a bicycle lane, or other lanes within a particular roadway or other travel way and/or one or more boundary markings associated therewith); and/or any other data that assists the vehicle computing system 102 in comprehending and perceiving its surrounding environment and its relationship thereto.

The vehicle state data 270 can include information regarding vehicle state information associated with the vehicle 104. The vehicle computing system 102 can obtain the vehicle state information from one or more sources. For example, the vehicle computing system 102 can monitor the vehicle 104 to determine one or more vehicle attributes (e.g., vehicle activity information) associated with the vehicle 104, and store information indicative of the determination in the vehicle state data 270 as the vehicle state information. As another example, the vehicle computing system 102 can obtain data indicative of one or more vehicle attributes (e.g., vehicle schedule information) associated with the vehicle 104 from the operations computing system 120. Additionally, the vehicle computing system 102 can send the vehicle state data 270, or at least a part thereof, to the operations computing system 120 at one or more times (e.g., via the Vehicle API platform). In some implementations, the vehicle state information can include other data relating to the collection, analysis, and transmission of the vehicle state information. In some implementations, the vehicle state data 270 can include vehicle assignment information regarding one or more vehicle assignments scheduled for the vehicle 104. The vehicle computing system 102 can obtain the vehicle assignment information from one or more sources. For example, the vehicle computing system 102 can obtain data indicative of vehicle assignment information associated with the vehicle 104 from the operations computing system 120.

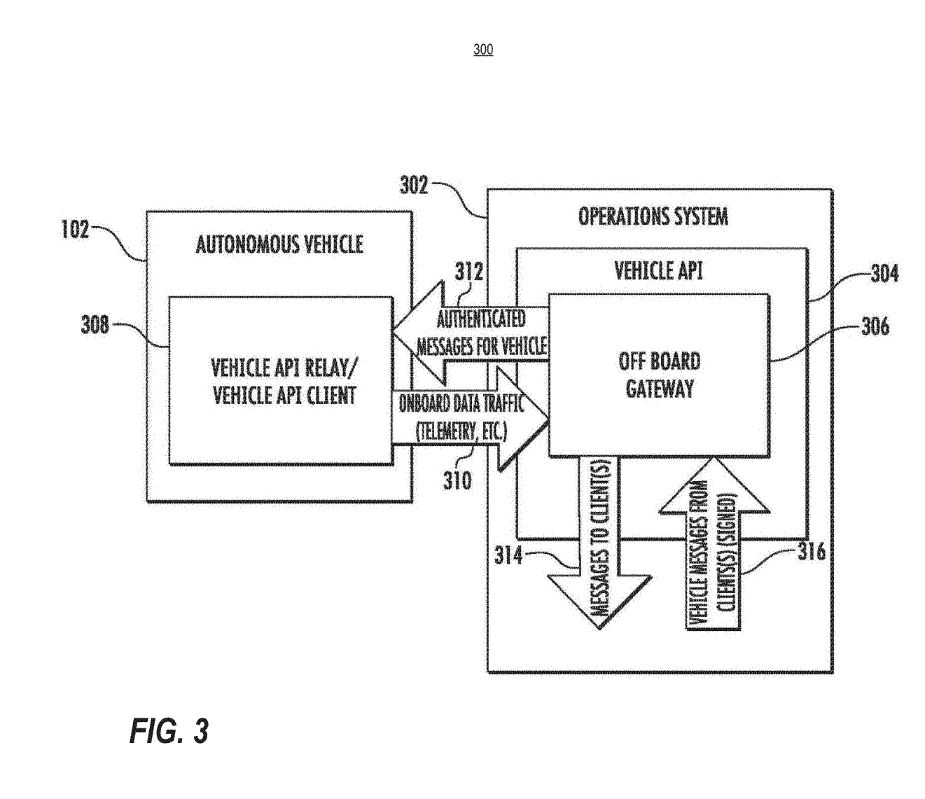

FIG. 3 depicts a block diagram of an example vehicle-operations system interface 300 according to example embodiments of the present disclosure. The systems and methods of the present disclosure can provide for secure, bidirectional communications between one or more vehicles in a service provider's fleet, such as the vehicle 104 and the service provider's operations or control center, such as an operations system 302 associated with the operations computing system 120.

As illustrated in FIG. 3, the vehicle-operations system interface 300 can include a Vehicle API 304 associated with an operations system 302. The Vehicle API 304 can provide for a translation/transport layer as an interface between vehicle computing systems onboard vehicles within an entity's fleet (e.g., vehicle 104, additional vehicle(s) 105, and/or the like) and one or more remote clients and/or applications operating within the entity's operations/control center (e.g., operations system 302).

The Vehicle API 304 can include an offboard gateway 306 which can provide for establishing one or more communication channels between the Vehicle API 304 and a vehicle, such as vehicle 104 (e.g., via vehicle computing system 102, etc.). The offboard gateway 306 can establish multiplexing connections between the vehicle 104 and the Vehicle API 304 that can be used to send arbitrary communications through the same connections.

In some implementations, the Vehicle API 304, through offboard gateway 306, can provide for establishing multiple hypertext transfer protocol (or other suitable protocol) connections, for example, using HTTP/2, between a Vehicle API relay/client 308 and the offboard gateway 306, allowing the ability to parallelize and assert traffic priority within a connection. In some implementations, the offboard gateway 306 of Vehicle API 304 can establish at least two hypertext transfer protocol (or other suitable protocol) connections, such as HTTP/2 connections, to the operations computing system from a vehicle, where at least one connection can be dedicated to high reliability, high deliverability traffic and at least one connection can be dedicated to best-effort, unguaranteed traffic. In some implementations, the use of multiple connections can allow for the underlying transport to be controlled in terms of different connections having different weights such that data can be identified as more important.

The vehicle 104 can include a Vehicle API relay/client 308, for example, associated with a vehicle computing system 102, which can provide for establishing the one or more communication channels between the offboard gateway 306 of the Vehicle API 304 and the vehicle 104. In some implementations, the Vehicle API relay/client 308 onboard the vehicle 104 can provide for communicating data using intelligent quality of service (QoS), multiplexing data over different communication streams, prioritizing and/or de-prioritizing data traffic dynamically, for example, based on link conditions and/or the like. In some implementations, the Vehicle API relay/client 308 can provide for making determinations about what data it thinks is more important and handling the communication of that data as appropriate.

In some implementations, the Vehicle API 304, through offboard gateway 306 and Vehicle API relay/client 308, can provide for communicating onboard data traffic 310 (e.g., telemetry, vehicle state information, etc.) from the vehicle 104 to the operations system 302. For example, the offboard gateway 306 can receive the onboard data traffic 310 from the Vehicle API relay/client 308 and the Vehicle API 304 can provide for handling the onboard data traffic 310 and providing the onboard data traffic 310 to one or more clients and/or application associated with the operations system 302 in client messages 314.

In some implementations, the Vehicle API 304, through offboard gateway 306 and Vehicle API relay/client 308, can provide for communicating authenticated vehicle messages 312 from the operations system 302 to the vehicle 104 (e.g., to a vehicle computing system, etc.). For example, the offboard gateway 306 can receive vehicle messages 316 from one or more clients/applications associated with the operations system 302 (e.g., messages signed by the client to allow for authenticating the messages before sending to a vehicle) and the Vehicle API 304 can provide for communicating the vehicle messages 316 to the vehicle 104, through offboard gateway 306 and Vehicle API relay/client 308, as authenticated vehicle messages 312 (e.g., once the Vehicle API 304 has authenticated the signed vehicle messages 316).

In some implementations, the Vehicle API 304 can allow for a vehicle 104 to send multiple types of data to the operations system 302 over the established connections with the vehicle 104. For instance, in some implementations, the Vehicle API 304 can provide for a vehicle 104 sending vehicle state data 270 to the operations system 302. In some implementations, the Vehicle API 304 can provide for a vehicle 104 to send low resolution perception data, such as labels and/or geometries, to the operations system, allowing for processing the data offboard the vehicle 104 by one or more clients/applications associated with the operations system 302 and allowing for developing a better understanding of the world. In some implementations, the Vehicle API 304 can provide for a vehicle to send data such as current vehicle pose (e.g., global and relative to map), vehicle trajectory, onboard diagnostics, and/or the like, to the operations system 302 to be processed by one or more clients/applications associated with the operations system 302, for example.

In some implementations, the Vehicle API 304 can provide for the operations system 302 to receive multiple types of data from the vehicle 104 and/or additional vehicle(s) 105. For example, the Vehicle API 304 can provide for the operations system 302 to receive multiple types of data from the vehicle 104 over the established connections with the vehicle 104. In some implementations, the Vehicle API 304 can provide for receiving vehicle state data 270 from the vehicle 104 at one or more times, and analyzing the vehicle state data 270 to determine a vehicle state associated with the vehicle 104.

In some implementations, the Vehicle API 304 can provide for the operations system 302 to aggregate data (e.g., vehicle state information) associated with the vehicle 104 and/or additional vehicle(s) 105. The operations system 302 can, for example, analyze the aggregated data to determine a vehicle utility and/or utilization score associated with the vehicle 104 and/or additional vehicle(s) 105. Additionally, the operations system 302 can, for example, determine a fleet utility and/or utilization score associated with fleet.

In some implementations, the Vehicle API 304 can provide for the operations system 302 to determine one or more utilization patterns associated with the vehicle 104 and/or additional vehicle(s) 105.

In some implementations, the Vehicle API 304 can provide for the operations system 302 to extrapolate the one or more utilization patterns associated with the vehicle 104 and/or additional vehicle(s) 105 to one or more future times to predict one or more vehicle attributes associated with the vehicle 104 and/or additional vehicle(s) 105 at the one or more future times. In some implementations, the operations system 302 can, for example, extrapolate the one or more utilization patterns to predict a future vehicle state associated with the vehicle 104 and/or additional vehicle(s) 105 at a future time, and predict a future vehicle utility and/or utilization associated with the vehicle 104 and/or additional vehicle(s) 105 at the future time. Additionally, the operations system 302 can, for example, predict a future fleet utility and/or utilization associated with the fleet at the future time.

In some implementations, the Vehicle API 304 can provide for the operations system 302 to send multiple types of data to the vehicle 104 and/or additional vehicle(s) 105. For example, the Vehicle API 304 can provide for the operations system 302 to send multiple types of data to the vehicle 104 over the established connections to the vehicle 104. For example, in some implementations, the Vehicle API 304 can provide for sending vehicle assignment data to the vehicle 104, such as instructions for the vehicle 104 to offload the data from its computing system, instructions for the vehicle 104 to report for maintenance, instructions for a vehicle to procure fuel, and/or the like. In some implementations, the Vehicle API 304 can provide for sending command signals to the vehicle 104, such as, for example, sending specific control messages to the vehicle 104, sending advisories to the vehicle 104, etc. The specific control messages can, for example, instruct the vehicle 104 to go to certain geographic coordinates. The advisories can, for example, notify a vehicle operator associated with the vehicle 104 about scheduled vehicle assignments, flagged geo regions (e.g., areas to avoid, areas to spend more time in to acquire passengers, areas under construction that should be routed around, etc.), etc.

In some implementations, the Vehicle API 304 can provide for the operations system 302 to schedule a vehicle assignment for the vehicle 104 and/or additional vehicle(s) 105. The operations system 302 can schedule a vehicle assignment for the vehicle 104 and/or additional vehicle(s) 105 at one or more future times.

In some implementations, the Vehicle API 304 can allow for the operations system 302 to select the vehicle 104 to implement a vehicle assignment at a future time based on a future vehicle state associated with the vehicle 104.

In some implementations, the Vehicle API 304 can allow for the operations system 302 to select vehicle 104 to implement a vehicle assignment at a future time based on a future vehicle state associated with the vehicle 104 and a future vehicle state associated with the additional vehicle(s) in the fleet at the future time.

In some implementations, the Vehicle API 304 can allow for the operations system 302 to determine one or more preconditions associated with a vehicle assignment. The operations system 302 can schedule the vehicle assignment based on the one or more preconditions.

In some implementations, the Vehicle API 304 can provide for the operations system 302 to edit a scheduled vehicle assignment. The operations system 302 can edit a scheduled vehicle assignment, for example, in response to determining updated vehicle state information and/or updated vehicle assignment information.

In some implementations, Vehicle API 304 can provide for the operations system 302 to send a control message to the vehicle 104 instructing the vehicle 104 to implement a scheduled vehicle assignment. For example, the operations system 302 can provide a control message instructing the vehicle 104 to autonomously travel to a location associated with the vehicle assignment at a scheduled time associated with the vehicle service.

In some implementations, the Vehicle API 304 can provide for the operations system 302 to send an advisory to the vehicle 104 to notify a vehicle operator associated with the vehicle 104 of a vehicle assignment scheduled for the vehicle 104. In some implementations, the operations system 302 can provide one or more advisories at one or more times ahead of a scheduled time associated with the vehicle assignment.

In some implementations, the Vehicle API 304 platform can provide for the operations system 302 to send an advisory to the vehicle 104 based on vehicle state information associated with the vehicle 104.

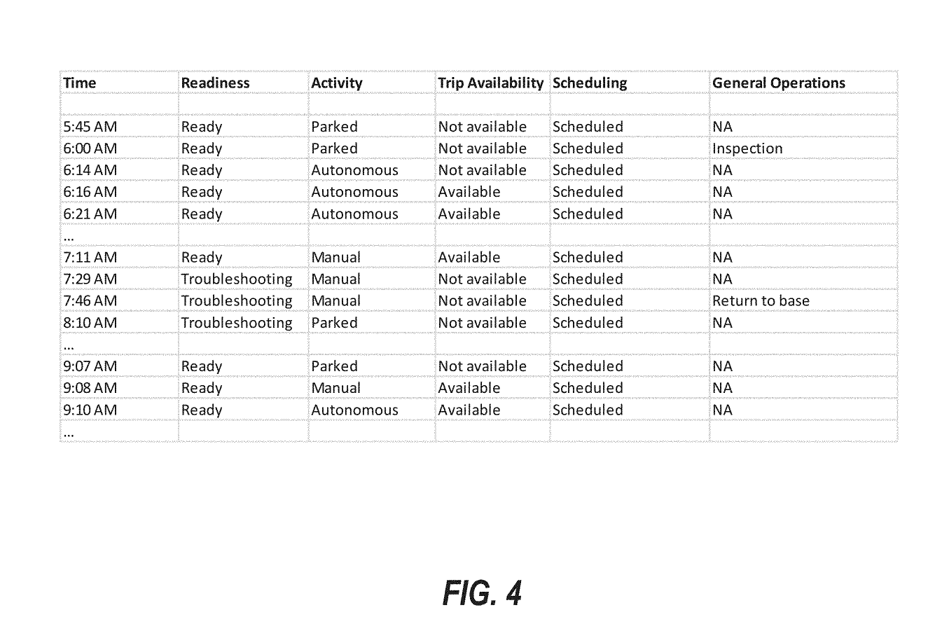

FIG. 4 depicts example vehicle state information according to example embodiments of the present disclosure. In some implementations, the vehicle state information depicted in FIG. 4 or variations thereof can be provided as part of a graphical user interface available at one or more computing systems, such as vehicle computing system 102 and/or operations computing system 120 or other remote computing system 103. As shown in FIG. 4, the vehicle state information can include vehicle activity information, vehicle schedule information, trip availability information, and vehicle readiness information. In particular, the vehicle state information can include one or more vehicle attributes that are associated with the vehicle 104 at one or more times.

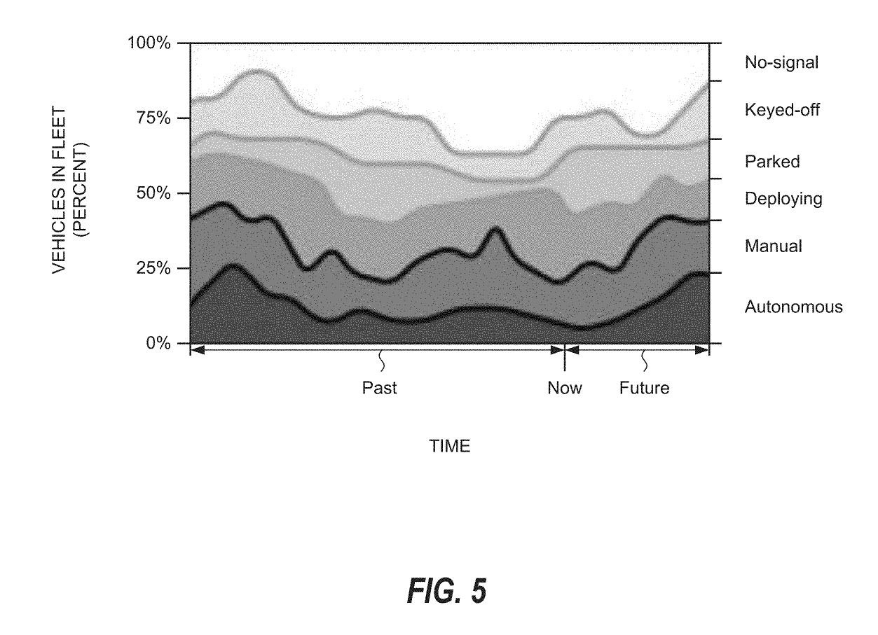

FIG. 5 depicts example aggregated vehicle state information according to example embodiments of the present disclosure. In some implementations, the aggregated vehicle state information depicted in FIG. 5 or variations thereof can be provided as part of a graphical user interface available at one or more computing systems, such as vehicle computing system 102 and/or operations computing system 120 or other remote computing system 103. As shown in FIG. 5, the aggregated vehicle state information can include vehicle activity information associated with a plurality of vehicles in the fleet at one or more times. FIG. 5 depicts a percentage of vehicles in the fleet that are associated with vehicle attributes indicative of vehicle activity information (e.g., autonomous mode, manual mode, deploying, parked, keyed-off, and no-signal) at a present time and one or more past times. FIG. 5 also depicts a prediction of what percentage of the vehicles in the fleet will be associated with each of the vehicle attributes one or more future times.

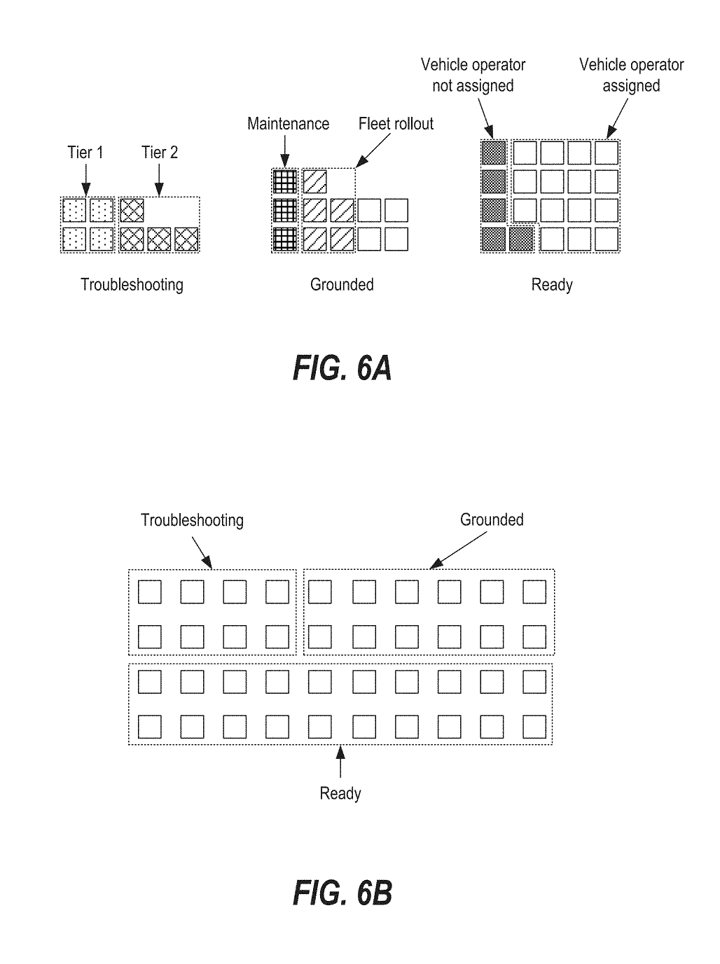

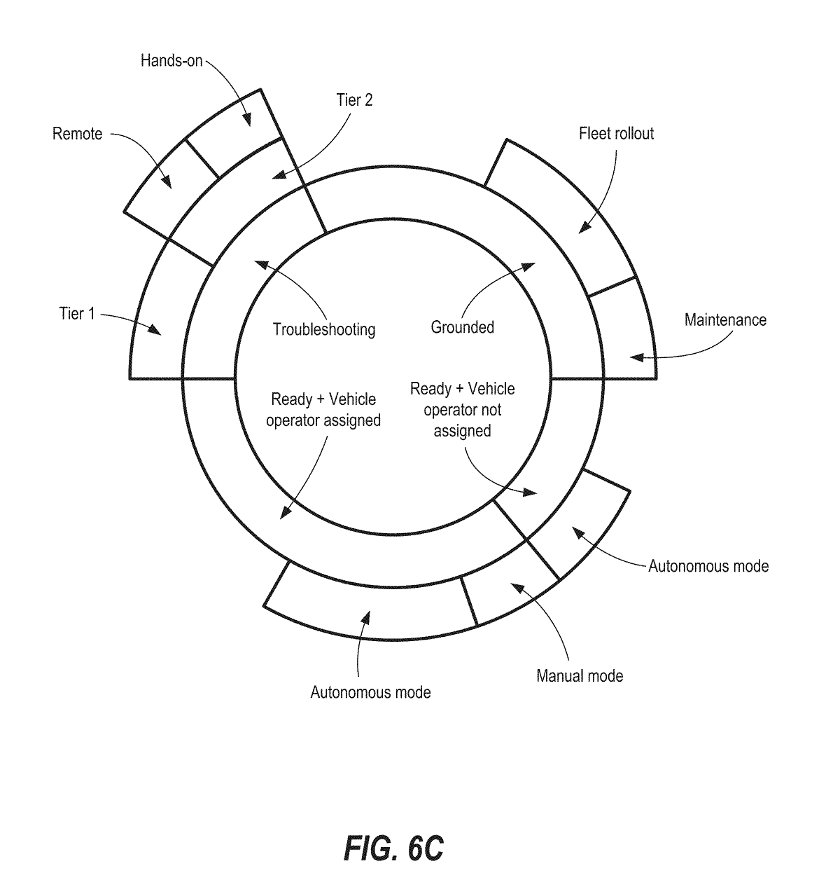

FIGS. 6A-6C depict example aggregated vehicle state information according to example embodiments of the present disclosure. In some implementations, the aggregated vehicle state information depicted in FIGS. 6A-6C or variations thereof can be provided as part of a graphical user interface available at one or more computing systems, such as vehicle computing system 102 and/or operations computing system 120 or other remote computing system 103. As shown in FIGS. 6A-6C, the aggregated vehicle state information can include vehicle readiness information, vehicle schedule information, and vehicle activity information associated with a plurality of vehicles in the fleet at a particular moment. FIGS. 6A-6C depict a graphical representation of vehicles in the fleet that are associated with vehicle attributes indicative of vehicle readiness information, vehicle schedule information, or vehicle activity information.

FIG. 6A depicts a first graphical representation of a distribution of the vehicles in the fleet based on an association of the vehicles with vehicle attributes indicative of troubleshooting, grounded, and ready. FIG. 6A additionally depicts a distribution of the vehicles associated with troubleshooting, based on an association of the vehicles with vehicle attributes indicative of tier 1 and tier 2. FIG. 6A additionally depicts a distribution of the vehicles associated with grounded, based on an association of the vehicles with vehicle attributes indicative of maintenance and fleet rollout. FIG. 6A additionally depicts a distribution of the vehicles associated with ready, based on an association of the vehicles with vehicle attributes indicative of a vehicle operator being assigned to the vehicles.

FIG. 6B depicts a second graphical representation of a distribution of the vehicles in the fleet based on an association of the vehicles with vehicle attributes indicative of troubleshooting, grounded, and ready.

FIG. 6C depicts a third graphical representation of a distribution of the vehicles in the fleet based on an association of the vehicles with vehicle attributes indicative of troubleshooting, grounded, and ready. FIG. 6C additionally depicts a distribution of the vehicles associated with troubleshooting and tier 2, based on an association of the vehicles with vehicle attributes indicative of remote troubleshooting and hand-on troubleshooting. FIG. 6C additionally depicts a distribution of the vehicles associated with ready, based on an association of the vehicles with vehicle attributes indicative of an autonomous mode and manual mode.

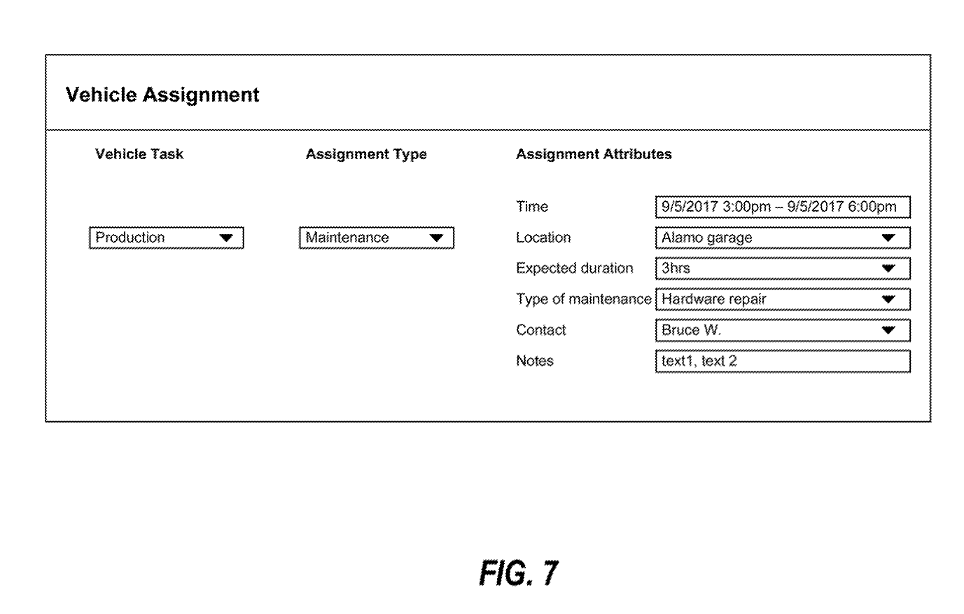

FIG. 7 depicts example vehicle assignment information according to example embodiments of the present disclosure. In some implementations, the vehicle assignment information depicted in FIG. 7 or variations thereof can be provided as part of a graphical user interface available at one or more computing systems, such as vehicle computing system 102 and/or operations computing system 120 or other remote computing system 103. As shown in FIG. 7, the vehicle assignment information can include a vehicle task during which the vehicle assignment is to be implemented, a type of the vehicle assignment (e.g., maintenance assignment, fleet rollout assignment, trade dressing assignment, or event assignment), assignment attributes (e.g., time, location, expected duration, contact, and notes).

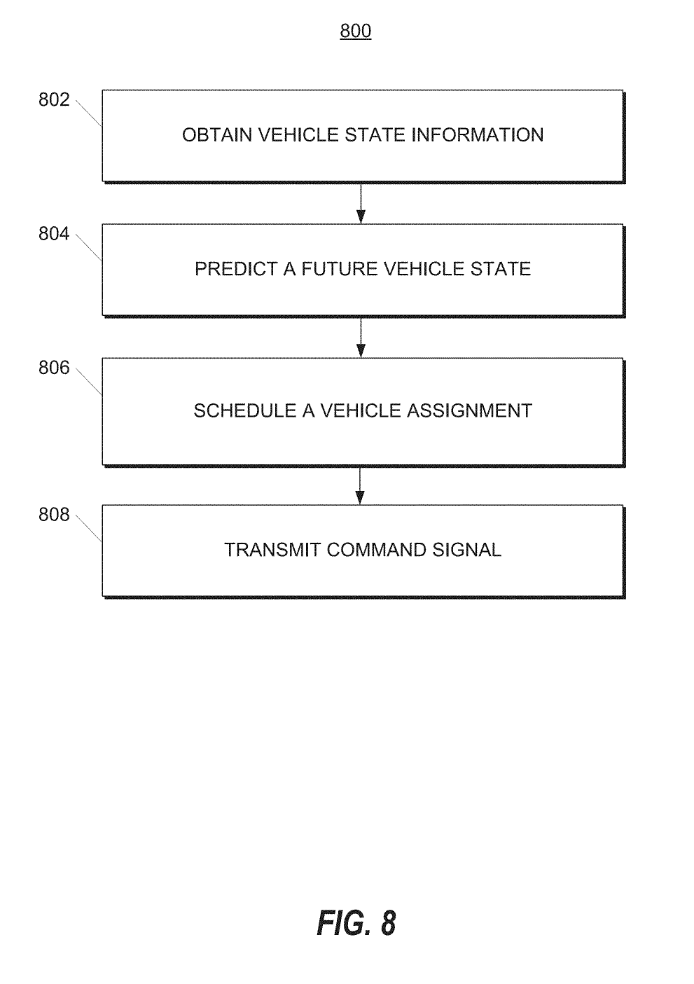

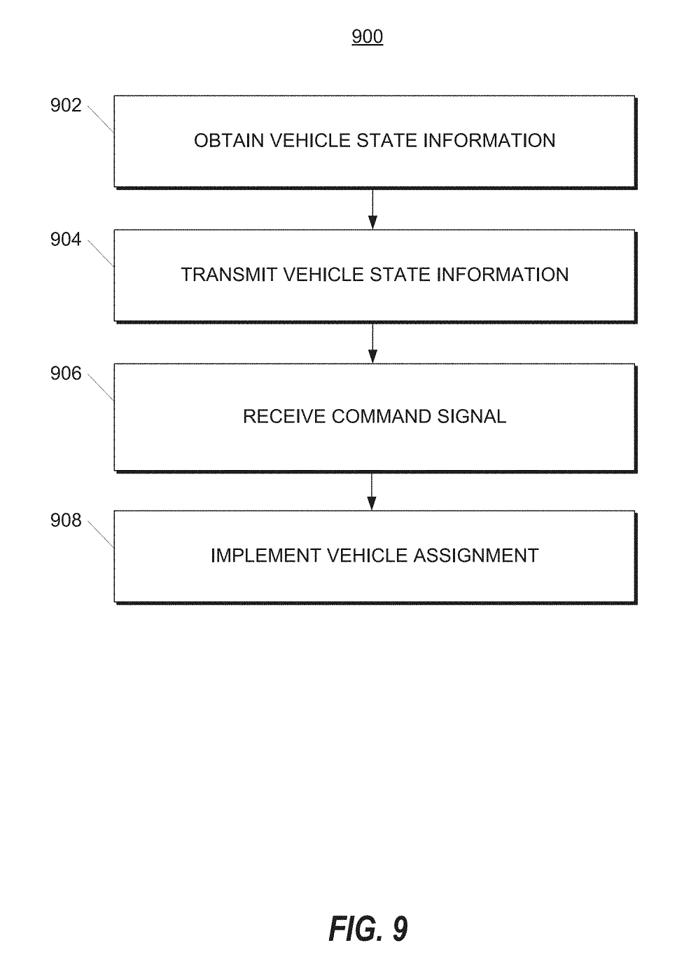

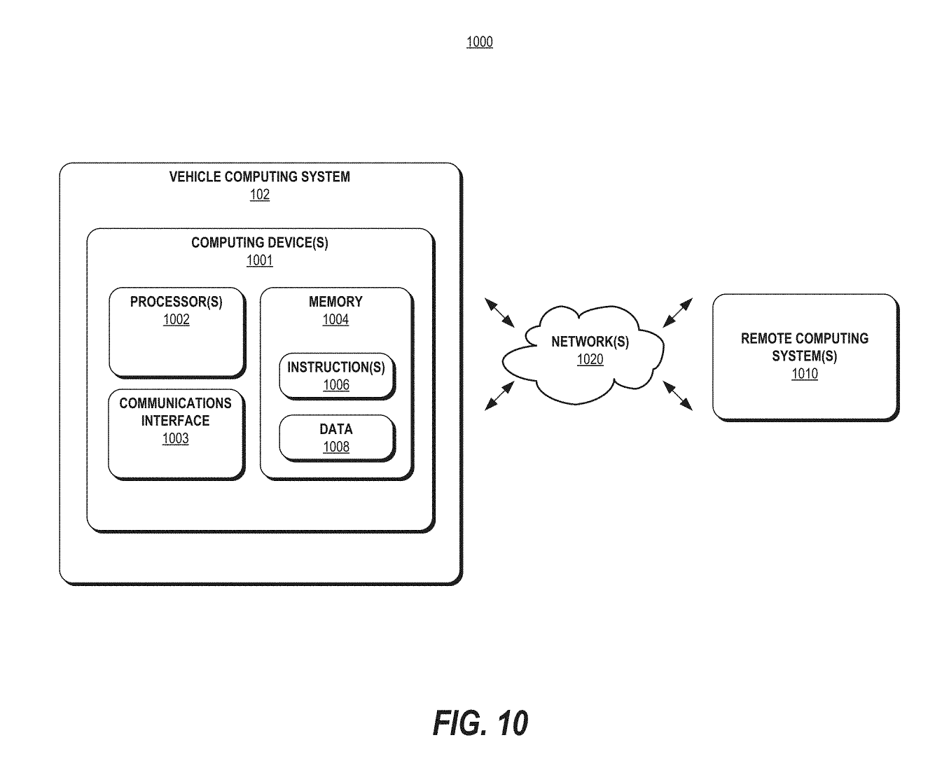

FIGS. 8 and 9 depict flow diagrams of example methods 800 and 900 according to example embodiments of the present disclosure. One or more portion(s) of the methods 800 and 900 can be implemented as operations by one or more computing system(s) such as, for example, the computing system(s) 102, 120, 1001, and 1010 shown in FIGS. 1 and 10. Moreover, one or more portion(s) of the methods 800 and 900 can be implemented as an algorithm on the hardware components of the system(s) described herein (e.g., as in FIGS. 1, 2, and 10) to, for example, manage a fleet of vehicles, or implement a vehicle assignment. FIGS. 8 and 9 depict elements performed in a particular order for purposes of illustration and discussion. Those of ordinary skill in the art, using the disclosures provided herein, will understand that the elements of any of the methods (e.g., of FIG. 8 or 9) discussed herein can be adapted, rearranged, expanded, omitted, combined, and/or modified in various ways without deviating from the scope of the present disclosure.

FIG. 8 depicts a diagram of a method 800 for managing a fleet of vehicles. At (802), the method 800 can include obtaining vehicle state information. For example, the operations computing system 120 can obtain data representing vehicle state information associated with the vehicle 104 and/or the additional vehicles 105 at one or more times. The vehicle state information can include one or more vehicle attributes associated with the vehicle 104 and/or the additional vehicles 105, the one or more vehicle attributes indicating one or more of a vehicle activity, vehicle schedule, trip availability, and vehicle readiness.

At (804), the method 800 can include predicting a future vehicle state. For example, the operations computing system 120 can predict a future vehicle state associated with the vehicle 104 and/or the additional vehicles 105 at one or more future times based at least in part on the vehicle state information. The operations computing system 120 can aggregate the vehicle state information associated with the vehicle 104 and/or the additional vehicles 105 at one or more times. The operations computing system 120 can analyze the aggregated vehicle state information to determine one or more utilization patterns associated with the vehicle 104 and/or the additional vehicles 105. In some implementations, the operations computing system 120 can determine one or more times when the vehicle 104 and/or the additional vehicles 105 are associated with one or more vehicle attributes, and determine a utilization pattern for each of the one or more vehicle attributes over a duration corresponding to the one or more times when the vehicle 104 and/or the additional vehicles 105 are associated with the one or more vehicle attributes. The operations computing system 120 can predict the future vehicle state associated with the vehicle 104 and/or the additional vehicles 105 at one or more future times based at least in part on the one or more utilization patterns. In some implementations, the operations computing system 120 can determine one or more vehicle utilization scores, each vehicle utilization score associated with the vehicle 104 and/or the additional vehicles 105 and based at least in part on a future vehicle state associated with the vehicle 104 and/or the additional vehicles 105 at the one or more future times; and determine a fleet utilization score associated with the fleet of vehicles, based at least in part on the one or more vehicle utilization scores. In some implementations, the operations computing system 120 can update the predicted future vehicle state associated with the vehicle 104 and/or the additional vehicles 105 at the first future time, and select a vehicle to implement the vehicle assignment among the vehicle 104 and/or the additional vehicles 105 based at least in part on the updated future vehicle state associated with the vehicle 104 and/or the additional vehicles 105 at the first future time.

At (806), the method 800 can include scheduling a vehicle assignment. For example, the operations computing system 120 can schedule a vehicle assignment in a predetermined set of vehicle assignments for the vehicle 104 and/or the additional vehicles 105 before a first future time among the one or more future times based at least in part on a future vehicle state associated with the vehicle 104 and/or the additional vehicles 105 at the first future time. The predetermined set of vehicle assignments can include one or more assignments based at least in part on vehicle state information associated with the vehicle 104 and/or the additional vehicles 105, and/or one or more assignments based at least in part on a predetermined calendar of events. In some implementations, the operations computing system 120 can determine one or more preconditions associated with the vehicle assignment, predict one or more future times when the one or more preconditions are met, and schedule the vehicle assignment for the vehicle 104 and/or the additional vehicles 105 at a future time based at least in part on the one or more future times when the one or more preconditions are met. In some implementations, the operations computing system 120 can select a vehicle to implement the vehicle assignment among the vehicle 104 and/or the additional vehicles 105 based at least in part on a future vehicle state associated with the vehicle 104 and/or the additional vehicles 105 at the future time, and schedule the vehicle assignment for the selected vehicle based at least in part on a future vehicle state associated with the selected vehicle at the future time. In some implementations, the operations computing system 120 can edit one or more assignment attributes associated with the vehicle assignment, at one or more times before the first future time. In some implementations, the operations computing system 120 can select a first vehicle among the vehicle 104 and/or the additional vehicles 105 at a first time before the first future time, schedule the vehicle assignment for the first vehicle at the first time, select a second vehicle among the vehicle 104 and/or the additional vehicles 105 at a second time before the first future time, and reschedule the vehicle assignment for the second vehicle at the second time.

At (808), the method 800 can include transmitting a command signal. For example, the operations computing system 120 can transmit a command signal to a computing system associated with the vehicle 104 and/or the additional vehicles 105 based at least in part on the scheduled vehicle assignment. In some implementations, the operations computing system 120 can transmit a command signal to provide an advisory that notifies a vehicle operator associated with the vehicle 104 and/or the additional vehicles 105 about the scheduled vehicle assignment for the vehicle 104 and/or the additional vehicles 105, the advisory including one or more assignment attributes associated with the scheduled vehicle assignment. In some implementations, the operations computing system 120 can transmit a command signal to control the vehicle 104 and/or the additional vehicles 105 to autonomously implement the scheduled vehicle assignment.

FIG. 9 depicts a diagram of a method 900 for implementing a vehicle assignment. At (902), the method 900 can include obtaining vehicle state information. For example, the vehicle computing system 102 can obtain data representing vehicle state information associated with the vehicle 104 at one or more collection times. The vehicle state information can include one or more vehicle attributes associated with the vehicle 104, the one or more vehicle attributes indicating one or more of a vehicle activity, vehicle schedule, trip availability, and vehicle readiness.

At (904), the method 900 can include transmitting vehicle state information. For example, the vehicle computing system 102 can transmit the vehicle state information to one or more remote computing systems at one or more transmission times.

At (906), the method 900 can include receiving a command signal. For example, the vehicle computing system 102 can receive a command signal from the one or more remote computing systems, the command signal indicative of a scheduled vehicle assignment for the vehicle 104 based at least in part on the vehicle state information. In some implementations, the vehicle computing system 102 can receive a command signal to provide an advisory that notifies a vehicle operator associated with the vehicle 104 about the scheduled vehicle assignment for the vehicle 104, the advisory including one or more assignment attributes associated with the scheduled vehicle assignment.

At (908), the method 900 can include implementing a vehicle assignment. For example, the vehicle computing system 102 can control, in response to the command signal, the vehicle 104 to implement the scheduled vehicle assignment based at least in part on the command signal. In some implementations, the vehicle computing system 102 can receive a command signal to autonomously control the vehicle 104 to implement the scheduled vehicle assignment.

FIG. 10 depicts an example computing system 1000 according to example embodiments of the present disclosure. The example system 1000 illustrated in FIG. 10 is provided as an example only. The components, systems, connections, and/or other aspects illustrated in FIG. 10 are optional and are provided as examples of what is possible, but not required, to implement the present disclosure. The example system 1000 can include the vehicle computing system 102 of the vehicle 104 and, in some implementations, remote computing system(s) 1010 including one or more remote computing system(s) that are remote from the vehicle 104 (e.g., operations computing system 120) that can be communicatively coupled to one another over one or more networks 1020. The remote computing system 1010 can be associated with a central operations system and/or an entity associated with the vehicle 104 such as, for example, a vehicle owner, vehicle manager, fleet operator, service provider, etc.

The computing device(s) 1001 of the vehicle computing system 102 can include processor(s) 1002 and a memory 1004. The one or more processors 1002 can be any suitable processing device (e.g., a processor core, a microprocessor, an ASIC, a FPGA, a controller, a microcontroller, etc.) and can be one processor or a plurality of processors that are operatively connected. The memory 1004 can include one or more non-transitory computer-readable storage media, such as RAM, ROM, EEPROM, EPROM, one or more memory devices, flash memory devices, etc., and combinations thereof.

The memory 1004 can store information that can be accessed by the one or more processors 1002. For instance, the memory 1004 (e.g., one or more non-transitory computer-readable storage mediums, memory devices) on-board the vehicle 104 can include computer-readable instructions 1006 that can be executed by the one or more processors 1002. The instructions 1006 can be software written in any suitable programming language or can be implemented in hardware. Additionally, or alternatively, the instructions 1006 can be executed in logically and/or virtually separate threads on processor(s) 1002.

For example, the memory 1004 on-board the vehicle 104 can store instructions 1006 that when executed by the one or more processors 1002 on-board the vehicle 104 cause the one or more processors 1002 (the vehicle computing system 102) to perform operations such as any of the operations and functions of the vehicle computing system 102, as described herein, one or more operations of method 1000, and/or any other operations and functions of the vehicle computing system 102, as described herein.

The memory 1004 can store data 1008 that can be obtained, received, accessed, written, manipulated, created, and/or stored. The data 1008 can include, for instance, data associated with perception, prediction, motion plan, maps, vehicle diagnostics, vehicle state information, vehicle assignment information, and/or other data/information as described herein. In some implementations, the computing device(s) 1001 can obtain data from one or more memory device(s) that are remote from the vehicle 104.

The computing device(s) 1001 can also include a communication interface 1003 used to communicate with one or more other system(s) on-board the vehicle 104 and/or a remote computing device that is remote from the vehicle 104 (e.g., of remote computing system(s) 1010). The communication interface 1003 can include any circuits, components, software, etc. for communicating via one or more networks (e.g., 1020). In some implementations, the communication interface 1003 can include, for example, one or more of a communications controller, receiver, transceiver, transmitter, port, conductors, software, and/or hardware for communicating data.

The network(s) 1020 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof, and can include any number of wired or wireless links. Communication over the network(s) 1020 can be accomplished, for instance, via a communication interface using any type of protocol, protection scheme, encoding, format, packaging, etc.

The remote computing system 1010 can include one or more remote computing devices that are remote from the vehicle computing system 102. The remote computing devices can include components (e.g., processor(s), memory, instructions, data) similar to that described herein for the computing device(s) 1001. Moreover, the remote computing system(s) 1010 can be configured to perform one or more operations of the operations computing system 120, as described herein. Moreover, the computing systems of other vehicles described herein can include components similar to that of vehicle computing system 102.

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for managing a fleet of vehicles, the method comprising:
obtaining, by a computing system comprising one or more computing devices, data representing vehicle state information associated with one or more vehicles among a fleet of vehicles at one or more times;
predicting, by the computing system, a future vehicle state associated with the one or more vehicles at one or more future times based at least in part on the vehicle state information;
scheduling, by the computing system, a vehicle assignment in a predetermined set of vehicle assignments for a selected vehicle among the one or more vehicles before a first future time of the one or more future times based at least in part on a future vehicle state associated with the selected vehicle at the first future time; and
transmitting, by the computing system, a command signal to a computing system associated with the selected vehicle based at least in part on the scheduled vehicle assignment.

2. The computer-implemented method of claim 1, wherein the vehicle state information includes one or more vehicle attributes associated with the one or more vehicles, the one or more vehicle attributes indicating one or more of a vehicle activity, vehicle schedule, trip availability, and vehicle readiness.

3. The computer-implemented method of claim 1, wherein the predetermined set of vehicle assignments includes one or more assignments based at least in part on vehicle state information associated with the vehicle.

4. The computer-implemented method of claim 1, wherein the predetermined set of vehicle assignments includes one or more assignments based at least in part on a predetermined calendar of events.

5. The computer-implemented method of claim 1, wherein predicting, by the computing system, a future vehicle state associated with the one or more vehicles at one or more future times based at least in part on the vehicle state information comprises:
aggregating, by the computing system, the vehicle state information associated with one or more vehicles at multiple times;
analyzing, by the computing system, the aggregated vehicle state information to determine one or more utilization patterns associated with the one or more vehicles; and
predicting, by the computing system, the future vehicle state associated with the one or more vehicles at one or more future times based at least in part on the one or more utilization patterns.

6. The computer-implemented method of claim 5, wherein analyzing, by the computing system, the aggregated vehicle state information to determine one or more utilization patterns associated with the one or more vehicles comprises:
determining, by the computing system, multiple times when each of the one or more vehicles is associated with each of one or more vehicle attributes; and
determining, by the computing system, a utilization pattern for each of the one or more vehicle attributes over a duration corresponding to the multiple times when the one or more vehicles are associated with the one or more vehicle attributes.

7. The computer-implemented method of claim 5, wherein predicting, by the computing system, the future vehicle state associated with the one or more vehicles at one or more future times based at least in part on the one or more utilization patterns comprises:
determining, by the computing system, one or more vehicle utilization scores, each vehicle utilization score associated with a vehicle in the one or more vehicles and based at least in part on a future vehicle state associated with the vehicle at the one or more future times; and
determining, by the computing system, a fleet utilization score associated with the fleet of vehicles, based at least in part on the one or more vehicle utilization scores.

8. The computer-implemented method of claim 1, wherein scheduling, by the computing system, a vehicle assignment in a predetermined set of vehicle assignments for a selected vehicle among the one or more vehicles before a first future time of the one or more future times based at least in part on a future vehicle state associated with the selected vehicle at the first future time comprises:
determining, by the computing system, one or more preconditions associated with the vehicle assignment;
predicting, by the computing system, one or more future times when the one or more preconditions are met;
scheduling, by the computing system, the vehicle assignment for the selected vehicle at a future time based at least in part on the one or more future times when the one or more preconditions are met.

9. The computer-implemented method of claim 1, wherein scheduling, by the computing system, a vehicle assignment in a predetermined set of vehicle assignments for a selected vehicle among the one or more vehicles before a first future time of the one or more future times based at least in part on a future vehicle state associated with the selected vehicle at the first future time comprises:
selecting, by the computing system, a vehicle to implement the vehicle assignment among the one or more vehicles based at least in part on a future vehicle state associated with the one or more vehicles at the future time; and
scheduling, by the computing system, the vehicle assignment for the selected vehicle based at least in part on a future vehicle state associated with the selected vehicle at the future time.

10. The computer-implemented method of claim 1, further comprising:
editing, by the computing system, one or more assignment attributes associated with the vehicle assignment, at one or more times before the first future time.

11. The computer-implemented method of claim 1, further comprising:
updating, by the computing system, the predicted future vehicle state associated with the one or more vehicles at the first future time; and
selecting, by the computing system, a vehicle to implement the vehicle assignment among the one or more vehicles based at least in part on the updated future vehicle state associated with the one or more vehicles at the first future time.

12. The computer-implemented method of claim 1, wherein scheduling, by the computing system, a vehicle assignment in a predetermined set of vehicle assignments for a selected vehicle among the one or more vehicles before a first future time of the one or more future times based at least in part on a future vehicle state associated with the selected vehicle at the first future time comprises:
selecting, by the computing system, a first vehicle among the one or more vehicles at a first time before the first future time;
scheduling, by the computing system, the vehicle assignment for the first vehicle at the first time;
selecting, by the computing system, a second vehicle among the one or more vehicles at a second time before the first future time; and
rescheduling, by the computing system, the vehicle assignment for the second vehicle at the second time.

13. The computer-implemented method of claim 1, wherein transmitting, by the computing system, a command signal to a computing system associated with the vehicle based at least in part on the scheduled vehicle assignment comprises:
transmitting, by the computing system, a command signal to provide an advisory that notifies a vehicle operator associated with the vehicle about the scheduled vehicle assignment for the vehicle, the advisory including one or more assignment attributes associated with the scheduled vehicle assignment.

14. The computer-implemented method of claim 1, wherein transmitting, by the computing system, a command signal to a computing system associated with the vehicle based at least in part on the scheduled vehicle assignment comprises:
transmitting, by the computing system, a command signal to control the vehicle to autonomously implement the scheduled vehicle assignment.

15. A computer-implemented method for implementing a vehicle assignment, the method comprising:
obtaining, by a computing system comprising one or more computing devices, data representing vehicle state information associated with a vehicle at one or more collection times;
transmitting, by the computing system, the vehicle state information to one or more remote computing systems at one or more transmission times;
receiving, by the computing system, a command signal from the one or more remote computing systems, the command signal indicative of a scheduled vehicle assignment for the vehicle based at least in part on the vehicle state information; and
controlling, by the computing system, in response to the command signal, the vehicle to implement the scheduled vehicle assignment based at least in part on the command signal.

16. The computer-implemented method of claim 15, wherein the vehicle state information includes one or more vehicle attributes associated with the vehicle, the one or more vehicle attributes indicating one or more of a vehicle activity, vehicle schedule, trip availability, and vehicle readiness.

17. The computer-implemented method of claim 15, wherein receiving, by the computing system, a command signal from the one or more remote computing system, the command signal indicative of a scheduled vehicle assignment for the vehicle comprises:
receiving, by the computing system, a command signal to provide an advisory that notifies a vehicle operator associated with the vehicle about the scheduled vehicle assignment for the vehicle, the advisory including one or more assignment attributes associated with the scheduled vehicle assignment.

18. The computer-implemented method of claim 15, wherein receiving, by the computing system, a command signal from the one or more remote computing system, the command signal indicative of a scheduled vehicle assignment for the vehicle comprises:
receiving, by the computing system, a command signal to autonomously control the vehicle to implement the scheduled vehicle assignment.

19. A computing system for managing a fleet of vehicles, the system comprising:
a fleet of vehicles;
a fleet manager that manages the fleet of vehicles;
one or more processors; and
one or more tangible, non-transitory, computer readable media that collectively store instructions that when executed by the one or more processors cause the computing system to perform operations, the operations comprising:
collecting, by one or more vehicle in the fleet, data representing vehicle state information associated with the one or more vehicles at one or more collection times;
transmitting, by the one or more vehicles, data representing the vehicle state information associated with the one or more vehicles, to the fleet manager at one or more transmission times;
obtaining, by the fleet manager, data representing the vehicle state information;
predicting, by the fleet manager, a future vehicle state associated with the one or more vehicles at one or more future times based at least in part on the vehicle state information;
scheduling, by the fleet manager, a vehicle assignment in a predetermined set of vehicle assignments for a selected vehicle among the one or more vehicles before a first future time of the one or more future times based at least in part on a future vehicle state associated with the selected vehicle at the first future time;
transmitting, by the fleet manager, a command signal to the selected vehicle based at least in part on the scheduled vehicle assignment, the command signal indicative of the scheduled vehicle assignment for the selected vehicle;
receiving, by the selected vehicle, a command signal from the one or more remote computing systems, the command signal indicative of a scheduled vehicle assignment for the vehicle based at least in part on the vehicle state information; and
implementing, by the selected vehicle, the scheduled vehicle assignment in response to the command signal.
